(19) United States
(12) Patent Application Publication
(10) Pub. No.: US 2018/0264936 A1
(43) Pub. Date: Sep. 20, 2018

(54) LIQUID TANK WITH A RADIATOR

(71) Applicant: Veritas AG, Gelnhausen (DE)

(72) Inventors: Thomas Rösch, Linsengericht (DE); Wilfried Moh, Mühlhausen (DE)

(21) Appl. No.: 15/917,402

(22) Filed: Mar. 9, 2018

(30) Foreign Application Priority Data
Mar. 14, 2017 (DE) 10 2017 105 380.8

(51) Int. Cl. B60K 15/03; F01N 3/20; B60K 13/04

(52) U.S. Cl. CPC B60K 15/03177; B29C 49/22; F01N 3/2073; B60K 13/04; B60K 2015/03427; B60K 2015/03493; F01N 2240/16; F01N 2260/18; F01N 2530/06; F01N 2530/26; F01N 2530/18; F01N 2610/02; F01N 2610/1406; F01N 2610/10; B60K 15/03006

(57) ABSTRACT

The present disclosure relates to a liquid tank to accommodate liquid for use in a vehicle. The liquid tank may include a liquid tank shell including a concavity formed in the liquid tank shell that is accessible from an outer area of the liquid tank shell; and a heater disposed within the concavity and configured to heat the liquid tank shell.

### CROSS-REFERENCE TO RELATED APPLICATIONS

This application claims priority to German patent application No. 10 2017 105 380.8, entitled “FLÜSSIGKEITSTANK MIT EINEM HEIZKÖRPER”, and filed on Mar. 14, 2017 by the Applicant of this application. The entire disclosure of the German application is incorporated herein by reference for all purposes.

### BACKGROUND

The present disclosure concerns a liquid tank with a heating element for use in a vehicle. The present disclosure especially concerns a urea tank to accommodate an aqueous urea solution with a heating element in a vehicle.

The method of selective catalytic reduction (SCR) is used to reduce NOx emission during the operation of internal combustion engines, especially diesel engines, in which an aqueous urea solution is fed to the exhaust system of a vehicle. The urea solution being supplied can be accommodated in a liquid tank. Because the freezing point of the urea solution used here lies at about −11° C., the urea solution must be heated in the liquid tank when the outside temperatures are low in order to prevent freezing of the urea solution. For this reason, heating elements can be positioned within a liquid tank to heat the urea solution. However, the incorporation of heating elements inside a liquid tank is restricted by the geometry of the liquid tank and the installation capabilities and the fact the heating element may be damaged by the urea solution in the liquid tank.

Document DE 8 615 526 U1 describes a plastic fuel tank for vehicles. The plastic tank comprises two half-shells that form an upper half-shell and a lower half-shell of the fuel tank accordingly. The fuel tank, however, has no heating element for heating the fuel tank.

### SUMMARY

The underlying task of the disclosure is to provide a liquid tank with a heating element that is advantageously arranged on the liquid tank.

This task is solved by the object having the features according to the independent claim. Advantageous examples of the disclosure are [illustrated by] objects of the figures, the description, and the dependent claims.

According to one aspect of the disclosure, the task is solved by a liquid tank to accommodate a liquid in a vehicle having a liquid tank shell, with a concavity formed in the liquid tank shell that is accessible from an outer area of the liquid tank shell, and a heating element arranged in the concavity and designed to heat the liquid tank shell.

The liquid tank is formed specifically as a urea tank to accommodate an aqueous urea solution and includes an additive tank or an SCR tank.

Through the heating element's arrangement in the concavity the technical advantage is achieved that the liquid tank shell or tank bladder and therefore the liquid situated in the liquid tank or tank bladder can be effectively heated. In addition, the concavity of the liquid tank shell accessible from the outer area of the liquid tank shell makes it possible for the heating element to perform its activity from the outside after production of the liquid tank and inserted simply into the concavity in which it can be accommodated. The heating element therefore need not be positioned in an internal space of the liquid tank in order to heat the liquid in the liquid tank.

The concavity of the liquid tank shell accessible from the outer area of the liquid tank shell therefore forms a dome in the internal space of the liquid tank that is surrounded by liquid in the liquid tank. Effective heat transfer from the heating element to the dome extending in the internal space of the liquid tank and from there to the liquid in the liquid tank is made possible on this account. Because the heating element is inserted into the concavity from the outside, the heating element is not in direct contact with the liquid in the liquid tank so that electrical short circuits in the heating element, for example, [as a result of] urea deposits on the heating element and/or damage to the heating element, can be prevented.

The concavity is arranged especially in the bottom of the liquid tank shell so that the heating element on the bottom of the liquid tank shell can effectively heat the liquid collecting by means of gravity in the liquid tank.

In an advantageous example, the heating element is connected in heat-conducting fashion to a wall of the concavity in order to effectively heat the wall, in which case the heating element lies against the wall specifically in force-fitted, form-fitting, or bonded fashion.

This achieves the technical advantage that effective heat transfer from the heating element to the dome wall and from there to the liquid in the liquid tank can be ensured. Force-fitted, form-fitting, or bonded attachment of the heating element to the dome wall permits particularly effective heat transfer.

In another advantageous example, the heating element has a heat-conducting plastic in order to provide a heat-conducting connection between the heating element and the liquid tank shell, in which case the heat-conducting plastic specifically comprises an elastomer or thermoplastic elastomer.

This achieves the technical advantage that effective heat transfer from the heating element to the liquid tank shell via the heat-conducting plastic can be ensured because of the heat-conducting plastic. The heat-conducting plastic can comprise an elastomer or a thermoplastic elastomer, including an elastically deformable plastic. It is ensured by the elastic deformability of the heat-conducting plastic that the heating element matches the contour of the concavity such that it can be ensured that the heating element is effectively accommodated in the concavity. The occurrence of air gaps between the heating element and the concavity that may compromise effective heat transfer can be prevented on this account.

In another advantageous example, the heat-conducting plastic includes heat-conducting fillers.

Effective heat-conducting properties of the heat-conducting plastic can be ensured by means of [such] heat-conducting fillers, specifically metal particles.

In another advantageous example, the heating element has a metallic heat-conducting element in order to provide a heat-conducting connection from the heating element to the liquid tank shell via the metallic heat-conducting element, specifically via the heat-conducting plastic and in which the metallic heat-conducting element comprises an aluminum heat-conducting sheet.

This achieves the technical advantage that heat transfer overall between the heating element and the liquid tank shell can be improved by means of the metallic heat-conducting element, specifically an aluminum heat-conducting sheet. Heat is then effectively released from the heating element of the heater to the metallic heat-conducting element, such that the metallic heat-conducting element effectively conveys the absorbed heat to the liquid tank shell, specifically conveying it to the liquid tank shell via the heat-conducting plastic.

In another advantageous example, the heater has an electrical heating element to heat the heater, with the electrical heating element designed as an electric resistance heating element.

This achieves the technical advantage that the electric resistance heating element can be effectively connected to an electrical power supply in order to heat the heater.
In another advantageous example, the heater has an electrical heating element to heat the heater, with the electrical heating element designed as a positive temperature coefficient (PTC) heating element.

This achieves the technical advantage that a PTC heating element permits particularly effective heating of the heater. A PTC heating element also has the advantage that it includes an independent control function of heating power such that excessively strong heating of the heating element can be avoided. In particular, one or more PTC heating elements having one or more electric resistance heating elements may be combined in the heater.

In another advantageous example, the concavity is designed as a cylindrical concavity and the heater is designed as a cylinder [that is] introduced into the cylindrical concavity or the concavity is formed as a conical concavity and the heater is designed as a cone that is inserted into the conical concavity.

This achieves the technical advantage that formation of the heater as a cylinder or cone for introduction in a corresponding cylindrical or conical concavity makes possible effective matching of the geometry of the heater to the geometry of the concavity. If the heater is designed as a cone, the heater can act particularly effectively on the concavity by means of pressure and in so doing prevent air gaps between the heater and the concavity.

In another advantageous example, the liquid tank has a closure designed to close the concavity with the heater accommodated in it, in which an elastic element, specifically a closure spring, is arranged specifically between the closure and the heater, which is designed to act upon the heater by means of a force so as to fix the heater in heat-conducting contact in the concavity.

This achieves the technical advantage that advantageous positioning of the heater in the concavity can be ensured by the closure and, in particular, the elastic element advantageously fixes the heater in heat-conducting contact in the concavity.

In another advantageous example, an additional concavity is formed in a liquid tank shell that is accessible from the outer area of the liquid tank shell and in which the liquid tank has an additional heater arranged in an additional concavity, in which case the additional heater is designed to heat the liquid tank shell, and the concavity and the additional concavity are arranged on the bottom of the liquid tank shell.

This achieves the technical advantage that, because of the additional heater, a greater heating power can be furnished than when only a single heater is used. Several additional concavities may be arranged to accommodate several additional heaters on the liquid tank. Owing to the fact that the concavity and the additional concavity are arranged specifically on the bottom of the liquid tank shell, the heaters can effectively heat the bottom of the liquid tank shell. Because the liquid situated in the liquid tank collects on the bottom of the liquid tank shell owing to gravity, particularly effective heating of the liquid in the liquid tank can be ensured on this account.

In another advantageous example, the liquid tank shell includes a first liquid tank half-shell with a first connection element that extends from a first inside wall of the first liquid tank half-shell in an internal space of the liquid tank and in which the liquid tank shell includes a second liquid tank half-shell with a second connection element that extends from a second inside wall of the second liquid tank half-shell into the internal space of the liquid tank, in which the first connection element and the second connection element are connected to each other in the internal space of the liquid tank and in which the concavity extends from the outer area of the liquid tank shell into the first connection element or the second connection element and in which the first connection element and/or the second connection element is specifically a column-shaped section of the first liquid tank half-shell and/or the second liquid tank half-shell.

This achieves the technical advantage that the connection elements ensure a stable connection between the liquid tank half-shells of the liquid tank. Owing to the fact that the concavity extends from the outer area of the liquid tank shell into the first connection element or into the second connection element, the corresponding connection element also serves to accommodate the heater that is inserted from the outer area of the liquid tank shell into the corresponding connection element. Because the corresponding connection element has the concavity, no additional concavities need be arranged on the liquid tank shells, which simplifies production of the liquid tank. The liquid tank half-shells can then each be formed with several connection elements, each of which can have a concavity into which the heater can be introduced. The column-like first and/or second connection element can have a cylindrical, conical, or stellate design and thus ensure stable connection elements with a concavity.

In another advantageous example, the first connection element has a first contact surface, the second connection element has a second contact surface, and the first contact surface can be fastened to the second contact surface in order to connect the first connection element to the second connection element.

This achieves the technical advantage that a stable connection is ensured between the first and second liquid tank half-shells.

In another advantageous example, the first contact surface and the second contact surface are welded or glued to each other, at least one of the contact surfaces including a recess to accommodate welding or glue excess.

This achieves the technical advantage that a widespread and stable connection between the first connection element and the second connection element can be provided.

In another advantageous example, the first liquid tank half-shell has a first stabilization element to stabilize the first connection element on the first inside wall and/or the second liquid tank half-shell has second stabilization elements to stabilize the second connection element on the second inside wall, the first stabilization elements and the second stabilization elements being designed in particular as stabilization ribs and/or stabilization beads.

This achieves the technical advantage that, because of the stabilization elements, the stability of the connection elements on the liquid tank half-shells is increased such that the strength of the liquid tank is further improved. A stabilization rib here includes an elongated elevation on the transitional area between the corresponding connection element and the corresponding liquid tank half-shell. A stabilization bead is a groove-like thickening between the corresponding connection element and the corresponding liquid tank half-shell.

In another advantageous example, the first stabilization elements and the second stabilization elements are arranged on the inside of the corresponding connection element facing the internal space of the liquid tank or are arranged on the outside of the corresponding connection element facing the outer area of the liquid tank and in which the first stabilization elements and the second stabilization elements extend along the longitudinal direction of the corresponding connection element or the first stabilization elements and the second stabilization elements are arranged in stellate fashion or radially around the corresponding connection element.

This achieves the technical advantage that an arrangement of the stabilization elements on the outside or inside of the corresponding connection elements ensures effective stabilization of the connection elements on the liquid tank shells.

In a further advantageous example, the first liquid tank half-shell and the first connection element are formed in one piece by means of an injection-molded part, specifically a plastic molded part, and/or the second liquid tank half-shell and the second connection element are formed in one piece by means of an injection-molded part, specifically a plastic molded part.

This achieves the technical advantage that the connection elements can be produced in a limited volume and the volume of the liquid tank is increased, that good force introduction from the connection element to the liquid tank half-shell can be achieved, and the liquid tank shell can be produced together with the connection element in one working step.

In another advantageous example, the liquid tank has a baffle to inhibit liquid movement in the liquid tank. This achieves the technical advantage that a baffle ensures effective inhibition of liquid movement.

### BRIEF DESCRIPTION OF THE DRAWINGS

Examples of the present disclosure are shown in the drawings and further described below.

FIG. 1 shows a schematic view of a liquid tank with a liquid tank shell;

FIG. 2 shows a view of a liquid tank with a liquid tank shell;

FIG. 3 shows a view of a liquid tank with a liquid tank shell and a heater accommodated in a concavity of the liquid tank shell;

FIG. 4 shows a view of a liquid tank with a heater according to the first example; and

FIG. 5 shows a view of a liquid tank with a heater according to the second example.

### DETAILED DESCRIPTION

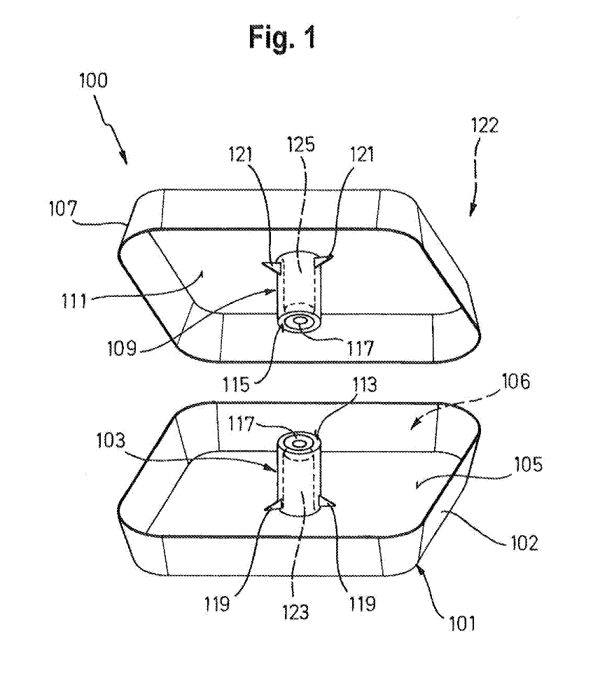

FIG. 1 shows a schematic view of a liquid tank used to accommodate liquid with a liquid tank shell. The liquid tank 100 is designed specifically as a urea tank to accommodate an aqueous urea solution. The method of selective catalytic reduction (SCR) is used to reduce the emission of NOx during operation of an internal combustion engine, especially a diesel engine, in a vehicle, the urea solution being fed to an exhaust system of the vehicle. The urea solution being supplied can be accommodated in the liquid tank 100. Because the freezing point of the urea solution employed here lies at about −1° C., the urea solution must be heated in the urea tank when the outside temperatures are low in order to prevent freezing of the urea solution.

The liquid tank 100 shown in FIG. 1 has a liquid tank shell 101 formed from a lower, first liquid tank half-shell 102 and an upper, second liquid tank half-shell 107. The first liquid tank half-shell 102 includes a first connection element 103 that extends from a first inside wall 105 of the first liquid tank half-shell 102 into an inside space 106 of the liquid tank 100. The second liquid tank half-shell 107 includes a second connection element 109 that extends from a second inside wall 111 of the second liquid tank half-shell 107 into the inside space 106 of liquid tank 100.

In production of the liquid tank 100, the second liquid tank half-shell 107 and the first liquid tank half-shell 102 are combined and joined to each other along their edges. A first contact surface 113 of the first connection element 103 then comes in contact with a second contact surface 115 of the second connection element 109. The first and the second contact surfaces 113 and 115 are welded or glued to each other. A mechanically strong connection is thus achieved between the first connection element 103 and the second connection element 109 and the strength of the liquid tank 100 is improved.

Connection with the first and second connection elements 103 and 109 may also occur in a different way. For example, the first or second connection element 103 or 109 may also include snap devices that, during assembly, snap the first and the second liquid tank half-shells 102 and 107 into the opposite second or first connection elements 103 or 109. Generally, all examples that permit a mechanically strong connection between the first connection element 103 and the second connection element 109 may be used, in which case defined movements up to a stopping point in one direction are permitted.

As shown in FIG. 1, the first contact surface 113 and the second contact surface 115 each has a recess 117 designed to accommodate welding or glue excess, which is formed during welding or gluing of the first contact surface 113 with the second contact surface 115. The recesses 117 may be arranged as a concentric circle, as several concentric circles, or as cross-like recesses 117 on the first contact surface 113 or second contact surface 115. During a melting or pressing process, displaced material is accommodated in the recesses 117 such that the strength of the connection site is improved.

As shown in FIG. 1, the first liquid tank half-shell 102 has first stabilization elements 119 that are designed to stabilize the first connection element 103 against the first inside wall 105 of the first liquid tank half-shell 102, and the second liquid tank half-shell 107 has second stabilization elements 121 that are designed to stabilize the second connection element 109 against the second inside wall 111 of the second liquid tank half-shell 107. The stabilization elements 119, 121 are designed here as stabilization ribs, but may also be designed as stabilization beads. The stabilization elements 119, 121 are arranged on the inside of the corresponding connection elements 103, 109 facing the inside space 106 of the liquid tank 100 or on the outside of the corresponding connection elements 103, 109 facing an outer area 122 of the liquid tank 100. The stabilization elements 119, 121 extend along the longitudinal direction of the corresponding connection element 103, 109, and/or the stabilization elements 119, 121 are arranged in stellate fashion or radially around the corresponding connection elements 103, 109.

A concavity 123 and an additional concavity 125 are formed in the liquid tank shell 101, which, though not shown in FIG. 1, is accessible from the outer area 122 of the liquid tank 100. A heater not depicted in FIG. 1 may be arranged in the concavity 123 or the additional concavity 125 in order to heat the liquid tank shell 101. Though not shown in FIG. 1, the concavity 123 and/or the additional concavity 125 may be designed as a cylindrical concavity 123 or a conical concavity 123, in which the heater is formed as a cylinder or a cone, which is introduced into the corresponding cylindrical concavity 123 or conical concavity 123. An additional heater may also be accommodated in the additional concavity 125.

As shown in FIG. 1, the concavity 123 extends from the outer area 122 of the liquid shell 101 into the first connection element 103, and the additional concavity 125 extends into the second connection element 109. The first and/or second connection element 103, 109 is designed here as a column-like connection element 103, 109 and can have a cylindrical shape, a conical shape, or a stellate cross-section.

As an alternative, only the first connection element 103 can be formed with a concavity 123 or only the second connection element 109 can be formed with an additional concavity 125. A heater not depicted in FIG. 1 or an additional heater can be arranged in the concavity 123 and/or the additional concavity 125 in order to heat the liquid tank shell 101.

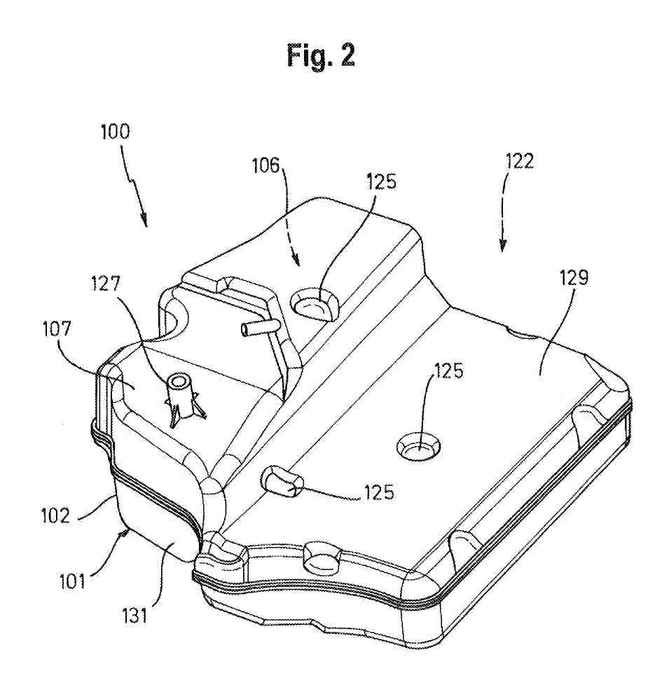

FIG. 2 shows a view of a liquid tank with a liquid tank shell. The liquid tank 100, for example, is a tank for [containing] an aqueous urea solution for use in a vehicle. The liquid tank shell 101 comprises a first and second liquid tank half-shell 102 and 107, which are plastic molded parts, for example, produced using an injection molding method. The first liquid tank half-shell 102 and the first connection element 103 are formed here in one piece, and the second liquid tank half-shell 107 and the second connection element 109 are formed in one piece. The plastics can include polyolefins, like polyethylene or polypropylene, polyamide, or polyoxymethylene (POM), specifically high-density polyethylene (HDPE).

Both liquid tank half-shells 102 and 107 are glued or welded to each other in the edge area and form a liquid cavity in the inside space 106 of liquid tank 100 into which the liquid can be filled. For this purpose the liquid tank 100 has filling connectors 127, via which the liquid can be filled into the liquid tank 100.

By using an injection molding technique, the liquid tank half-shells 102 and 107 can be produced weight- and cost-optimized, for example, using precise definition of the required wall thicknesses. In addition, components like pump flanges, connectors, and mounts can be integrated without [the need for] additional manufacturing steps. A clearly simplified assembly is achieved in the tank interior, because good accessibility is guaranteed by the open liquid tank half-shells 102 and 107.

The strength of the liquid tank 100 can be deliberately influenced locally by adapting an arrangement and configuration of stabilization elements 119, 121 and baffles. Production of the liquid tank half-shells 102 and 107 by means of an injection molding method is particularly advantageous, because the connection elements 103 and 109 can be produced in a small volume in contrast to production by means of a blow-molding method. The volume of the liquid tank 100 can be increased on this account.

The liquid tank 100 depicted in FIG. 2 includes three sites at which the connection elements 103, 109 are arranged within an inside space 106 of liquid tank 100 not depicted in FIG. 2. The second connection elements 109 are integrated in one piece in the second liquid tank half-shell 107 and each form an additional concavity 125 on a second outside wall 129, which is accessible from an outer area 122 of the liquid tank shell 101. Though not shown in FIG. 2, the first connection elements 103 are integrated in one piece in the first liquid tank half-shell 102 and have a concavity 123 on a first outside wall 131, which is also accessible from the outer area 122 of the first liquid tank half-shell 102. The first connection element 103 and the second connection element 109 after assembly of the liquid tank half-shells 102, 107 can be joined to each other, for example, by welding or screw connection, and heaters not shown in FIG. 2 can be introduced in the concavity 123 and/or the additional concavity 125.

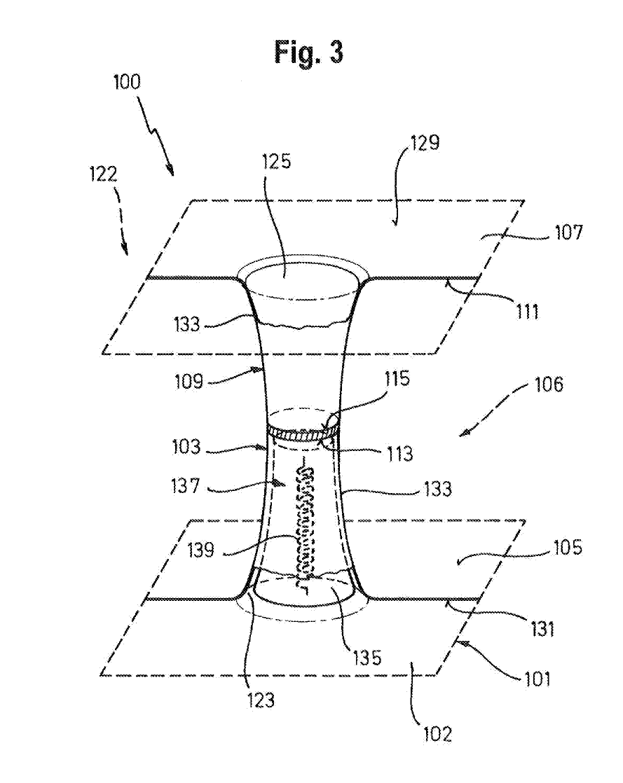

FIG. 3 shows a view of a liquid tank with a liquid tank shell and a heater accommodated in a concavity of the liquid tank shell. The first and second liquid tank half-shells 102 and 107 depicted schematically in FIG. 3, as well as a first inside wall 105 and a first outside wall 131, as well as a second inside wall 111 and a second outside wall 129. A first connection element 103 extends from the first inside wall 105, and a second connection element 109 extends from the second inside wall 111 into the inside space 106 of the liquid tank 100.

A first contact surface 113 of the first connection element 103 is fastened to a second contact surface 115 of the second connection element 109. The first and second contact surfaces 113, 115 are welded or glued to each other. An optional recess 117 of the first and/or second contact surface 113, 115 to accommodate the welding and/or glue flash is not shown in FIG. 3.

The first and second connection elements 103, 109 are designed as column-like sections of the first and second liquid tank half-shells 102, 107 and have a conical shape. A concavity 123 of the first liquid tank half-shell 102 extends into the first connection element 103, and an additional concavity 125 of the second liquid tank half-shell 107 extends into the second connection element 109. The concavity 123 and additional concavity 125 are each delimited by a dome wall 133.

A heater 135 is arranged in the concavity 123 of the first connection element 103, which is designed to heat the first connection element 103 and designed specifically as a heating cartridge. The heater 135 lies against the dome wall 133, specifically force-fitted, form-fitting, or bonded. The heater 135 includes an electrical heating element 139 designed specifically as an electrical resistance heating element, but as an alternative may be a PTC heating element. Though not shown in FIG. 3, the electrical heating element 139 is connected to an electric power supply in order to supply electrical power to the electrical heating element 139 to heat the first connection element 103.

The heater 135 may incorporate a heat-conducting plastic 137 in order to ensure effective heat conducting connection between the heater 135 and the dome wall 133. To ensure particularly effective heat transfer from the heating element 139 to the dome wall 133, the heat-conducting plastic 137 may include specifically heat-conducting fillers, such as metal particles. The heat-conducting plastic 137 may comprise specifically an elastomer or a thermoplastic elastomer or have elastically deformable properties that ensure effective fitting of the heater 135 into the concavity 123. The heat-conducting plastic 137 also provides electrical insulation between the heater 135 and the first connection element 103. To guarantee particularly effective heat transfer, the heater 135 may have a metallic heat-conducting element not shown in FIG. 3, the metallic heat-conducting element including specifically an aluminum heat-conducting sheet.

The heater 135, specifically the heating cartridge, may be pushed from the outer area 122 of the liquid tank 100 into the concavity 123 of the first liquid tank half-shell 102 and effectively positioned in concavity 123. By means of the heat-conducting plastic 137, effective accommodation of the heater 135 in the concavity 123 is ensured here, because the conically shaped heater 135 consisting of heat-conducting plastic 137 adapts to the conical shape of the concavity 123 in the first connection element 103. A tightly force-fitted, form-fitting, or bonded connection can be ensured on this account between the heater 135 and the concavity 123 such that gaps, or air sites that may compromise heat transfer, are avoided.

Though not shown in FIG. 3, liquid tank 100 may have a closure designed to close the concavity 123 with the heater 135 accommodated in it and therefore guarantee effective fixation of the heater 135 in the concavity 123. An elastic element, for example, a closure spring, is arranged between the closure and the heater 135 and is designed to act upon the heater 135 with a force in order to fix the heater 135 in the concavity 123.

In the example according to FIG. 3, a heater 135 is introduced into concavity 123. An additional heater may be introduced accordingly into the additional concavity 125 in order to heat the second connection element 109. It is also possible as an alternative that the heater 135 can be introduced into concavity 123 and an additional heater can be introduced into the additional concavity 125 in order to heat both the first connection element 103 and also the second connection element 109.

One or more heaters 135 can be accommodated in one or more concavities 123 of one or more first connection elements 103 in order to effectively heat the lower first liquid tank half-shell 102 and the liquid contained in it. This is particularly advantageous, because liquid introduced into the liquid tank 100 first collects by means of gravity after filling on the bottom of the first liquid tank half-shell 102.

The heater 135 therefore ensures effective heat transfer from the heater 135 to the first connection element 103, because a large surface is guaranteed for heat transfer between the heater 135 and the first connection element 103. It is ensured by the heat-conducting plastic 137 that heat transfer is not interrupted by the interruption of heat-conducting paths, such as air inclusions. An employed heat-conducting plastic 137 optionally provided with heat-conducting fillers must have good heat-conducting properties, be electrically insulated, and have elastic properties and permanent heat transfer when separations occur. Elastomers or thermoplastic elastomers, for example, elastomers with heat-conducting fillers, are well suited here for use as heat-conducting plastics 137.

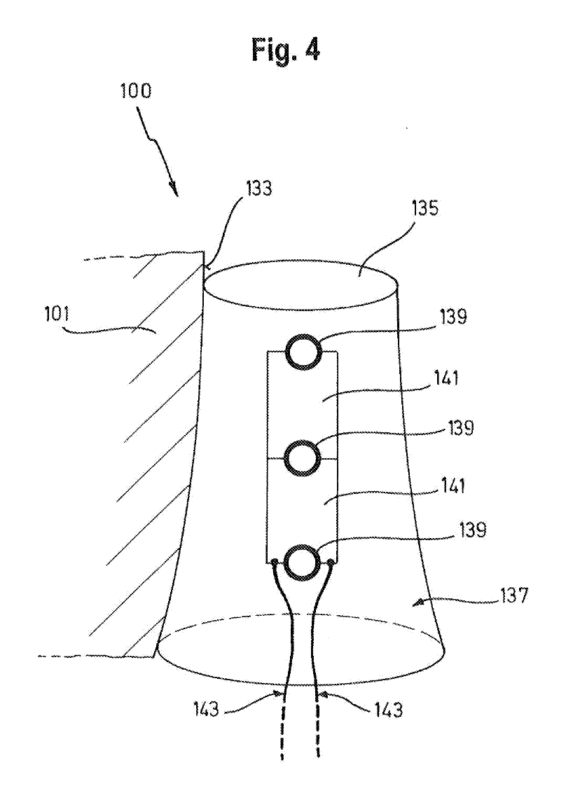

FIG. 4 shows a view of a liquid tank with a heater according to the first example.

The heater 135 is designed as a cone, which is introduced into a conical concavity 123 not shown in FIG. 4 of the liquid tank 100 and lies against a dome wall 133 of the liquid tank 100 free of gaps in order to ensure loss-free heat transfer from the heater 135 to the dome wall 133.

The heater 135 includes electrical heating elements 139 that are made specifically as PTC heating elements. The electrical heating elements 139 are arranged on conducting elements 141 and connected by electrical current lines 143 to an electrical power supply in order to supply electrical power to the electrical heating element 139 for heating.

The heater 135 may incorporate a heat-conducting plastic 137 in order to ensure effective heat-conducting connection between the heater 135 and the dome wall 133. In order to ensure particularly effective heat transfer between the heating element 139 and the dome wall 133, the heat-conducting plastic 137 may include especially heat-conducting fillers, such as metal particles.

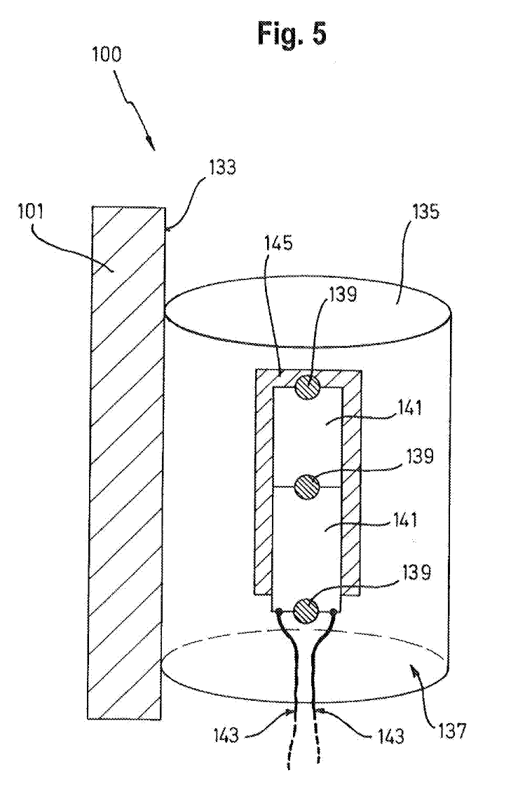

FIG. 5 shows a view of a liquid tank with a heater according to a second example.

The heater 135 is designed as a cylinder, which is introduced into a cylindrical concavity 123 of the liquid tank 100 not shown in FIG. 5 and lies against a dome wall 133 of the liquid tank 100 free of gaps in order to ensure loss-free heat transfer from heater 135 to the dome wall 133.

The heater 135 includes electrical heating elements 139 that are designed specifically as PTC heating elements. The electrical heating elements 139 are arranged on conducting elements 141 and connected by electrical current lines 143 to an electrical power supply in order to supply electrical power to the electrical heating element 139 for heating.

The heater 135 may incorporate a heat-conducting plastic 137 in order to ensure effective heat-conducting connection between the heater 135 and the dome wall 133. In order to ensure particularly effective heat transfer between the heating element 139 and the dome wall 133, the heat-conducting plastic 137 may include especially heat-conducting fillers, such as metal particles.

In order to improve heat transfer from the heating element 139 to the heat-conducting plastic 137, the heater 135 has a metallic heat-conducting element 145 that includes specifically an aluminum heat-conducting sheet. The metallic heat-conducting element 145 is specifically thermally connected to the heating element 139 in order to effectively divert heat generated by the heating element 139 and transfer it to the heat-conducting plastic 137 of the heater 135.

All features explained and depicted in conjunction with individual examples of the disclosure may be provided in different combinations with respect to the object according to the disclosure in order to simultaneously achieve their advantageous effects.

The protective scope of the present disclosure is stated by the claims and is not restricted by the features explained in the description or depicted in the figures.

### LIST OF REFERENCE NUMBERS

100 Liquid tank
101 Liquid tank shell
102 First liquid tank half-shell
103 First connection element
105 First inside wall of first liquid tank half-shell
106 Inside space of the liquid tank
107 Second liquid tank half-shell
109 Second connection element
111 Second inside wall of the second liquid tank half-shell
113 First contact surface
115 Second contact surface
117 Recess
119 First stabilization element
121 Second stabilization element
122 Outer area of the liquid tank
123 Concavity
125 Additional concavity
127 Filling connector
129 Second outside wall
131 First outside wall
133 Dome wall
135 Heater
137 Heat-conducting plastic
139 Electrical heating element
141 Conducting element
143 Electrical current line
145 Metallic heat-conducting element

What is claimed is:

1. A liquid tank to accommodate liquid for use in a vehicle comprising:
a liquid tank shell comprising a concavity formed in the liquid tank shell that is accessible from an outer area of the liquid tank shell; and
a heater disposed within the concavity and configured to heat the liquid tank shell.

2. The liquid tank according to claim 1, wherein the heater is connected in a heat-conducting manner to a dome wall of the concavity and is configured to heat the dome wall, and wherein the heater lies force-fitted, form-fitted, or bonded to the dome wall.

3. The liquid tank according to claim 1, wherein the heater comprises a heat-conducting plastic configured to provide a heat-conducting connection between the heater and the liquid tank shell, the heat-conducting plastic comprising an elastomer or a thermoplastic elastomer.

4. The liquid tank according to claim 3, wherein the heat-conducting plastic comprises heat-conducting fillers.

5. The liquid tank according to claim 1, wherein the heater comprises a metallic heat-conducting element configured to provide a heat-conducting connection from the heater via the metallic heat-conducting element to the liquid tank shell via the heat-conducting plastic.

6. The liquid tank according to claim 1, wherein the heater comprises an electric heating element configured to heat the heater, and wherein the electric heating element is configured as an electric resistance heating element.

7. The liquid tank according to claim 1, wherein the heater comprises an electric heating element configured to heat the heater, and wherein the electric heating element is configured as a positive temperature coefficient (PTC) heating element.

8. The liquid tank according to claim 1, wherein the concavity is configured as a cylindrical concavity and the heater is configured as a cylinder that is introduced into the cylindrical concavity, or wherein the concavity is configured as a conical concavity and the heater is configured as a cone that is introduced into the conical concavity.

9. The liquid tank according to claim 1, wherein the liquid tank comprises a closure configured to close the concavity with the heater accommodated in it, and wherein an elastic element is arranged between the closure and the heater that is configured to act upon the heater with a force to fix the heater in a heat-conducting contact in the concavity.

10. The liquid tank according to claim 1, wherein an additional concavity is formed in the liquid tank shell that is accessible from the outer area of the liquid tank shell, and wherein the liquid tank comprises an additional heater arranged in the additional concavity, the additional heater configured to heat the liquid tank shell, and wherein the concavity and the additional concavity are arranged on the bottom of the liquid tank shell.

11. The liquid tank according to claim 1, wherein the liquid tank shell comprises a first liquid tank half-shell with a first connection element that extends from a first inside wall of the first liquid tank half-shell into an internal space of the liquid tank, and wherein the liquid tank shell comprises a second liquid tank half-shell with a second connection element that extends from a second inside wall of the second liquid tank half-shell into the internal space of the liquid tank, the first connection element and the second connection element being connected to each other in the internal space of the liquid tank, and wherein the cavity extends from the outer area of the liquid tank shell into the first connection element or into the second connection element.

12. The liquid tank according to claim 11, wherein the first connection element comprises a first contact surface, wherein the second connection element comprises a second contact surface, and wherein the first contact surface is configured to be fastened to the second contact surface to connect the first connection element to the second connection element.

13. The liquid tank according to claim 11, wherein the first liquid tank half-shell comprises first stabilization elements configured to stabilize the first connection element on the first inside wall, and wherein the second liquid tank half-shell comprises second stabilization elements configured to stabilize the second connection element on the second inside wall, the first stabilization elements and the second stabilization elements configured as stabilization ribs, stabilization beads, or some combination thereof.

14. The liquid tank according to claim 13, wherein the first stabilization elements and the second stabilization elements are arranged on the inside of the corresponding connection element facing an internal space of the liquid tank or on the outside of the corresponding connection element facing an outside area of the liquid tank, and wherein the first stabilization elements and the second stabilization elements extend along the longitudinal direction of the corresponding connection element or the first stabilization elements and the second stabilization elements are arranged in stellate fashion or radially around the corresponding connection element.

15. The liquid tank according to claim 11, wherein the first liquid tank half-shell and the first connection element, the second liquid tank half-shell and the second connection element, or some combination thereof are formed in one piece as an injection-molded part.

16. The liquid tank according to claim 5, wherein the metallic heat-conducting element comprises an aluminum heat-conducting sheet.

17. The liquid tank according to claim 9, wherein the elastic element is a closure spring.

18. The liquid tank according to claim 11, wherein the first connection element, the second connection element, or a combination thereof is a column-like section of the first liquid tank half-shell, the second liquid tank half-shell, or some combination thereof.

19. The liquid tank according to claim 15, wherein the injection-molded part is a plastic-molded part.
